(19) United States
(12) Patent Application Publication
(10) Pub. No.: US 2026/0194222 A1
(43) Pub. Date: Jul. 9, 2026

(54) Light Strip Structure

(71) Applicant: Huizhou Victory Technology Ltd, Huizhou City (CN)

(72) Inventor: Hesheng Liu, Huaihua City (CN)

(73) Assignee: Huizhou Victory Technology Ltd, Huizhou City (CN)

(21) Appl. No.: 19/090,733

(22) Filed: Mar. 26, 2025

(30) Foreign Application Priority Data
Jan. 6, 2025 (CN) 202510016546.4

(51) Int. Cl. F21V 31/00; F21S 4/28; F21W 121/00

(52) U.S. Cl. CPC F21V 31/005; F21S 4/28; F21W 2121/00

(57) ABSTRACT

A light strip structure is provided, which includes a plurality of light strip units. The light strip units are provided with a supporting substrate, a light emitting element, and a resistor. The light emitting element and the resistor are provided on the supporting substrate. The light strip units are connected in parallel through the resistor. There is at least one light emitting element and at least one set of resistors. The light emitting element and the resistor are electrically connected. The design of the present disclosure, by providing the light strip structure inside or outside a handicraft shell, a texture effect on the handicraft is more beautiful.

### CROSS-REFERENCE TO RELATED APPLICATIONS

This application claims priority to Chinese Patent Application No. 202510016546.4, filed on Jan. 6, 2025, which is hereby incorporated by reference in its entirety.

### TECHNICAL FIELD

The present disclosure relates to the field of light strip technologies, and in particular, to a light strip structure.

### BACKGROUND

Handicrafts specifically refer to goods with certain artistic attributes that can meet the daily needs of the people in the industrial era, and have decorative and functional uses. Handicrafts come from people's lives, but they also create value that is higher than life. With the development of the times, people's demand for handicrafts is also increasing. Different themed handicrafts have been designed for different activities and festivals, and different texture effects have been designed on handicrafts.

The existing handicrafts have a single function and are generally only for ornamental purposes, rendering it difficult to reflect the texture effects on the designed Handicrafts. They are increasingly unable to meet people's needs and the market. Therefore, it is necessary to design a light strip structure that is simple in structure, low in cost, and can meet people's demand for the ornamental value of handicrafts to solve the above problems.

### SUMMARY

The purpose of the present disclosure is to provide a light strip structure to solve problems of single use function, high production cost, and inability to meet aesthetic needs in the background technology mentioned above.

The present disclosure provides the following technical solution: a light strip structure, including a plurality of light strip units, where the light strip units are provided with a supporting substrate, a light emitting element, and a resistor, where the light emitting element and the resistor are provided on the supporting substrate, the light strip units are connected in parallel through the resistor, there are at least one light emitting element and at least one set of resistors, the light emitting element and the resistors are electrically connected.

In some embodiments of the present disclosure, a waterproof adhesive layer is provided on the supporting substrate, the waterproof adhesive layer is provided above the supporting substrate, and the waterproof adhesive layer covers the light emitting element; or the waterproof adhesive layer is provided below the supporting substrate; or the waterproof adhesive layer is provided above and below the supporting substrate.

In some embodiments of the present disclosure, the waterproof adhesive layer is made of polyurethane material, epoxy resin or PVC material.

In some embodiments of the present disclosure, an insulation layer is provided on the supporting substrate, the light emitting element is provided above the supporting substrate, and the insulation layer is provided below the supporting substrate.

In some embodiments of the present disclosure, an adhesive layer is provided on the supporting substrate, and the adhesive layer is provided below or at a periphery the supporting substrate.

In some embodiments of the present disclosure, the supporting substrate is a flexible circuit board.

In some embodiments of the present disclosure, the light emitting element is an LED light bead, a SMD (Surface Mounted Device) light bead, or a COB (Chip on Board) light bead.

In some embodiments of the present disclosure, a thickness ratio of the supporting substrate and the waterproof adhesive layer is 1:1.5.

In some embodiments of the present disclosure, the light strip units have a thickness of 2 mm-5 mm.

In some embodiments of the present disclosure, one end of the light strip units is provided with a wire and an interface, the light strip units are connected to the interface through the wire, and the interface is connected to an external power source or a control chip.

In some embodiments of the present disclosure, the light strip structure can be provided inside or outside a handicraft shell through the adhesive layer.

In some embodiments of the present disclosure, the handicraft shell includes a first shell and a second shell; the first shell and the second shell are fixedly connected or integrally formed.

In some embodiments of the present disclosure, a cavity is formed inside the first shell and the second shell, and the light strip structure is provided inside the cavity.

In some embodiments of the present disclosure, the first shell and the second shell are clamping connected.

In some embodiments of the present disclosure, an overall outer shape of the handicraft shell is deer horn shape, wing shape, pentagram shape, triangular shape or circular shape.

In some embodiments of the present disclosure, a luminous effect of the light strip structure is constant light, strobe light, or scrolling light.

Compared with the existing technology, the beneficial effects of the present disclosure are as follows.

The light strip structure of the present disclosure includes a plurality of light strip units, the light strip units are provided with a carrying substrate, a light emitting element, and a resistor. The light emitting element and the resistor are provided on the carrying substrate, and the light strip units are connected in parallel through the resistor. There are at least one light emitting element and at least one set of resistors; the light emitting element and the resistor are electrically connected. The light strip units are connected in parallel, so that if one unit is damaged, it will not affect the other light strip units. By providing the light strip structure inside or outside the handicraft shell, a texture effect on the handicraft can be more beautiful, thereby effectively solving the problem of existing handicrafts having a single function and not meeting people's ornamental needs.

In the light strip structure of the present disclosure, the supporting substrate is a flexible circuit board. A waterproof adhesive layer, an insulation layer, and an adhesive layer are provided on the supporting substrate. The waterproof adhesive layer is provided on at least one side of the supporting substrate, the adhesive layer is provided on the insulation layer, and the insulation layer is provided on one side of the supporting substrate away from the light emitting element. With the flexible circuit board and adhesive layer, the light strip can be easily provided inside or outside the handicraft shell. With the insulation and adhesive layers, the light strip has waterproof, insulation, and short-circuit prevention functions, rendering it safer and more stable.

In the light strip structure of the present disclosure, the handicraft shell includes a first shell and a second shell, where the first shell and the second shell are fixedly connected or integrally formed. A cavity is formed inside the first and second shells, and the light strip structure is provided inside the cavity. By providing the light strip structure in the shell and connecting the light strip interface with the control chip, the handicraft can achieve the luminous effect of constant light, strobe light, or scrolling light, rendering the handicraft more ornamental.

### BRIEF DESCRIPTION OF DRAWINGS

In order to provide a clearer explanation of the embodiments or technical solutions in the present application or existing technology, a brief introduction will be given to the accompanying drawings required for the embodiments or existing technology description. It is obvious that the accompanying drawings described below are only some embodiments of the present application. For those skilled in the art, other drawings can be obtained based on these drawings without requiring creative work.

FIG. 1 is a schematic diagram of an internal structure of a light strip structure of the present disclosure.

FIG. 2 is a semi-sectional schematic diagram of the lamp strip structure of the present disclosure.

FIG. 3 is a schematic diagram of the light strip structure of the present disclosure installed in a handicraft shell.

FIG. 4 is a schematic diagram of the light strip structure of the present disclosure installed outside of the handicraft shell.

FIG. 5 is a partial sectional view of the light strip structure of the present disclosure installed on the handicraft shell.

Numeral reference: 1—light strip unit; 11—supporting substrate; 12—light emitting element; 13—resistor; 14—waterproof adhesive layer; 15—insulation layer; 16—adhesive layer; 2—wire; 3—interface; 4—handicraft shell; 41—first shell; 42—second shell; 43—cavity.

### DESCRIPTION OF EMBODIMENTS

The following provides a detailed description of the embodiments of the present application, embodiments of which are shown in the accompanying drawings, where the same or similar reference numerals from beginning to end represent the same or similar elements or elements with the same or similar functions. The embodiments described below with reference to the accompanying drawings are exemplary and are only used to explain the present application, and should not be construed as limiting the present application.

In a description of this application, it should be understood that terms “first” and “second” are only used for a descriptive purpose and cannot be understood as indicating or implying relative importance or implying the number of technical features indicated. Thus, the features limited to “first” and “second” may explicitly or implicitly include one or more of the aforementioned features. In the description of this application, the meaning of “multiple” refers to two or more, unless otherwise specifically limited.

In the description of this application, it should be noted that unless otherwise specified and limited, terms “installation” and “connection” should be broadly understood, for example, it can be a fixed connection, a detachable connection, or an integrated connection; it can be a mechanical connection, an electrical connection, or communication with each other; it can be directly connected or indirectly connected through an intermediate medium, and it can be a connection within two components or an interaction relationship between two components. For those skilled in the art, the specific meanings of the above terms in this application can be understood according to a specific situation.

In the description of this application, it should be understood that terms “up”, “down”, “side”, “front”, “back”, etc. indicate orientation or position relationships based on installation, only for the convenience of describing this application and simplifying the description, and do not indicate or imply that the device or component referred to must have a specific orientation, be constructed and operated in a specific orientation, and therefore cannot be understood as a limitation of this application.

In the description of this application, it should be noted that term “and/or” is only a description of the association relationship between related objects, indicating that there can be three types of relationships, such as A and/or B, which can represent: the existence of A alone, the existence of A and B at the same time, and the existence of B alone.

It should be noted that in the embodiments of the present application, the same reference numerals are used to represent the same components or parts. For the same parts in the embodiments of the present application, only one part or component may be marked with a reference numeral in the figure. It should be understood that for other identical parts or components, the reference numerals are also applicable.

Besides that, in this application, the technical features described in an open manner include both closed technical solutions composed of the listed features and open technical solutions containing the listed features.

In order to further understand the disclosure, characteristics, and efficacy of the present application, the following embodiments are listed and explained in detail with the accompanying drawings:

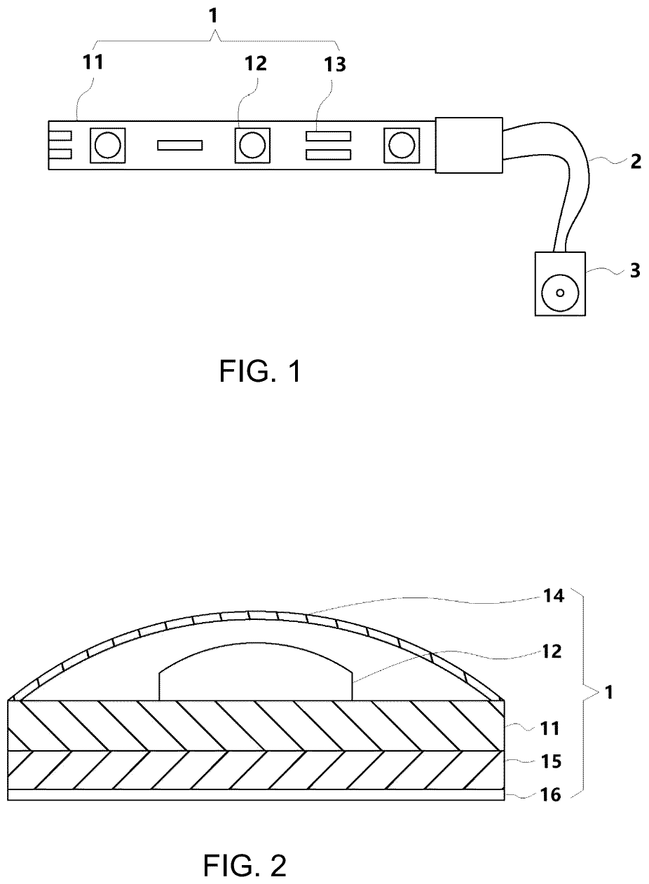

As shown in FIGS. 1-2, a light strip structure includes a plurality of light strip units 1. The light strip units 1 are provided with a supporting substrate 11, a light emitting element 12, and a resistor 13. The light emitting element 12 and the resistor 13 are provided on the supporting substrate 11. The light strip units 1 are connected in parallel through the resistor 13. There are at least one light emitting element 12 and at least one set of resistors 13. The light emitting element 12 and the resistor 13 are electrically connected. In this embodiment, the light strip units are connected in parallel, so that if one unit is damaged, it will not affect the other light strip units. By providing the light strip structure inside or outside a handicraft shell, a texture effect on the handicraft can be more beautiful, thereby effectively solving a problem of existing handicrafts having a single function and not meeting people's ornamental needs. Of course, the above structural design is not limited to this and can also be other structures that serve the same purpose.

In an implementation mode, as shown in FIG. 2, a waterproof adhesive layer 14 is provided on the supporting substrate 11, and the waterproof adhesive layer 14 is provided above the supporting substrate 11, the waterproof adhesive layer 14 covers the light emitting element 12; or the waterproof adhesive layer 14 can be provided below the supporting substrate 11; or the waterproof adhesive layer 14 can be provided above and below the supporting substrate 11. In this embodiment, the waterproof adhesive layer is provided above the supporting substrate, and the waterproof adhesive layer covers the light emitting element. By providing with the waterproof adhesive layer, the light strip structure has waterproof function. Of course, the structural design is not limited to this and can also be other structures that serve the same purpose.

In an implementation mode, the waterproof adhesive layer 14 is made of polyurethane material, epoxy resin, or PVC material. In this embodiment, the waterproof adhesive layer is made of PVC material, which has good transparency, plasticity, insulation, and thermal insulation properties. Of course, the type of waterproof adhesive layer is not limited to this and can also be other materials that have the same effect.

In an implementation mode, an insulation layer 15 is provided on the supporting substrate 11, the light emitting element 12 is provided above the supporting substrate 11, and the insulation layer 15 is provided below the supporting substrate 11. In this embodiment, by providing with the insulation layer, the light strip structure has insulation function and is not easily short circuited. Of course, the structural design is not limited to this and can also be other structures that serve the same purpose.

In an implementation mode, an adhesive layer 16 is provided on the supporting substrate 11, and the adhesive layer 16 is provided below or at a periphery of the supporting substrate 11. The adhesive layer can be provided below, left, or right of the supporting substrate, or at the periphery of the supporting substrate. In this embodiment, the adhesive layer is provided below the supporting substrate, and through the adhesive layer, the light strip structure can be more conveniently fixed inside or outside the handicraft shell. Of course, the structural design is not limited to this and can also be other structures that serve the same purpose.

In an implementation mode, the supporting substrate 11 is a flexible circuit board. In this embodiment, the flexible circuit board can be used for the installation of shells of different shapes, with high compatibility. Of course, the type of supporting substrate is not limited to this, and it can also be other supporting substrates that serve the same purpose.

In an implementation mode, the light emitting element 12 is an LED bead, a SMD bead, or a COB bead. In this embodiment, the light emitting element is an LED bead that can emit various colors of light, including white light, warm white light, natural white light, and colored light. Furthermore, it has low energy consumption and low heat generation, rendering it suitable for long-term use. Of course, the type of light emitting element is not limited to this, and it can also be other light emitting elements that serve the same purpose.

In an implementation mode, a thickness ratio of the supporting substrate 11 to the waterproof adhesive layer 14 is 1:1.5, and the light strip units 1 have a thickness of 2 mm-5 mm. Of course, the light strip units can also have other thicknesses.

In an implementation mode, one end of the strip units 1 is provided with a wire 2 and an interface 3. The strip units 1 are connected to the interface 3 through the wire 2, and the interface 3 is connected to an external power source or a control chip. In this embodiment, the light strip units are connected to the external power source through the interface and powered by the wire. Of course, the above structural design is not limited to this and can also be other structures that serve the same purpose.

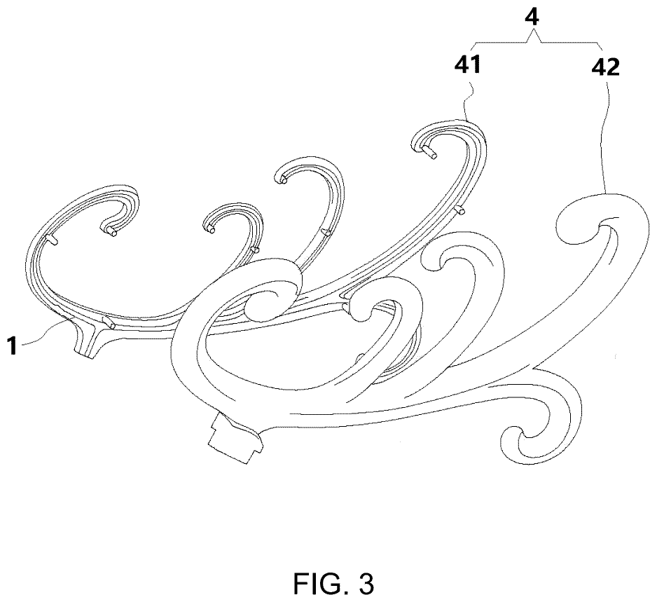

In an implementation mode, as shown in FIG. 3, the light strip structure is fixedly provided inside and/or outside a handicraft shell 4. The handicraft shell 4 is a structure composed of two pieces or a single shell structure. In this embodiment, the handicraft shell is a structure composed of two pieces, and the light strip structure is fixed inside the handicraft shell to achieve a luminous effect. Of course, the above structural design is not limited to this and can also be other structures that serve the same purpose.

In an implementation mode, the handicraft shell 4 includes a first shell 41 and a second shell 42, which are fixedly connected or integrally formed. In this embodiment, the first shell and the second shell are fixedly connected, rendering assembly more convenient through this connection method. Of course, the above structural design is not limited to this and can also be other structures that serve the same purpose.

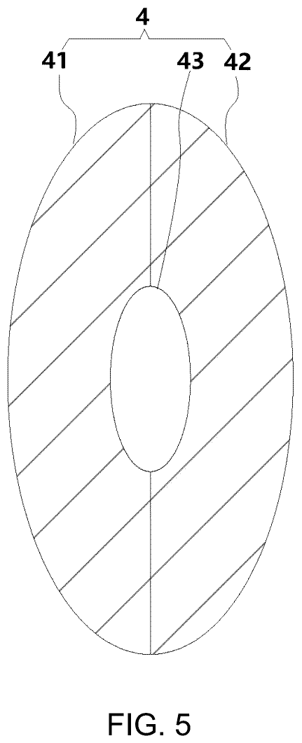

In an implementation mode, as shown in FIG. 5, a cavity 43 is formed inside the first shell 41 and the second shell 42, and the light strip structure is provided inside the cavity 43 and/or outside the first shell 41 and/or the second shell 42. In this embodiment, the light strip structure is provided inside the cavity, and through this structural design, the shell achieves a luminous effect, rendering the handicrafts more beautiful. Of course, the above structural design is not limited to this and can also be other structures that serve the same purpose.

In an implementation mode, the first shell 41 and the second shell 42 are clamping connected. In this embodiment, the first shell and the second shell are clamping connected, which renders the installation of the shell faster and more convenient, thereby effectively improving production efficiency. Of course, the connection method is not limited to this and can also be other connection methods that serve the same purpose.

In an implementation mode, a shape of the handicraft shell 4 can be deer horn shape, wing shape, pentagram shape, triangular shape or circular shape. In this embodiment, the shape of the handicraft shell is deer horn shape. Of course, the shape of the shell is not limited to this and can also be other shapes that serve the same purpose.

In an implementation mode, a luminous effect of the light strip structure is constant light, strobe light, or scrolling light. In this implementation, one end of the light strip structure is connected to the control chip through wires and interfaces, and the lighting effect can be adjusted according to the requirements through the settings of the control chip. Of course, it is not limited to this and can have other luminous effects.

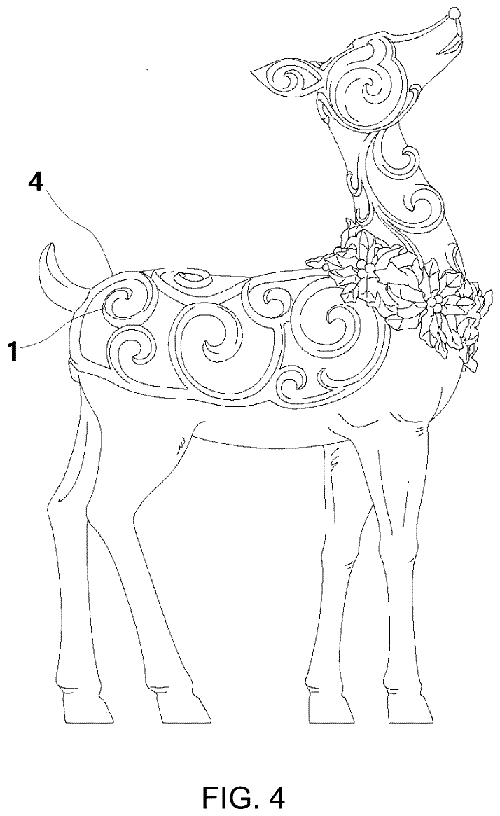

In an implementation mode, as shown in FIG. 4, the light strip structure is fixedly provided inside and/or outside the handicraft shell 4. The handicraft shell 4 is a structure composed of two pieces or a single shell structure. In this embodiment, the handicraft shell is a single shell structure, and the light strip structure is fixed outside of the handicraft shell to achieve a luminous effect. Of course, the above structural design is not limited to this and can also be other structures that serve the same purpose.

Working principle: by the flexible circuit board, the light strip structure can be easily provided inside or outside the handicraft shell, enabling the handicraft to achieve a luminous effect. The light strip structure is connected to a control chip, which can control the light strip structure to achieve constant light, strobe light, or scrolling light effects according to requirements. It can render the texture effect on handicrafts more beautiful, thereby effectively solving the problem of existing handicrafts having a single function and unable to meet people's ornamental needs.

The various technical features of the above embodiments can be combined in any way. In order to render the description concise, not all possible combinations of the various technical features in the above embodiments have been described. However, as long as there is no contradiction in the combination of these technical features, they should be considered within the scope of this application.

The above embodiments only express some embodiments of the present disclosure, and their descriptions are more specific and detailed, but should not be understood by limiting the scope of the present application. It should be noted for those skilled in the art, serval modifications and improvements can be made without departing from the inventive concept, which are within the protection scope of the present disclosure. Therefore, the protection scope of the present application should be based on the appended claims.

What is claimed is:

1. A light strip structure, comprising a plurality of light strip units, wherein the light strip units are provided with a supporting substrate, a light emitting element, and a resistor,
wherein the light emitting element and the resistor are provided on the supporting substrate, the light strip units are connected in parallel through the resistor,
there are at least one light emitting element and at least one set of resistors, the light emitting element and the resistors are electrically connected.

2. The light strip structure according to claim 1, wherein a waterproof adhesive layer is provided on the supporting substrate, the waterproof adhesive layer is provided above the supporting substrate, and the waterproof adhesive layer covers the light emitting element; or
the waterproof adhesive layer is provided below the supporting substrate; or
the waterproof adhesive layer is provided above and below the supporting substrate.

3. The light strip structure according to claim 2, wherein the waterproof adhesive layer is made of polyurethane material, epoxy resin or PVC material.

4. The light strip structure according to claim 1, wherein an insulation layer is provided on the supporting substrate, the light emitting element is provided above the supporting substrate, and the insulation layer is provided below the supporting substrate.

5. The light strip structure according to claim 1, wherein an adhesive layer is provided on the supporting substrate, and the adhesive layer is provided below or at a periphery the supporting substrate.

6. The light strip structure according to claim 5, wherein the supporting substrate is a flexible circuit board.

7. The light strip structure according to claim 6, wherein the light emitting element is an LED light bead, a SMD light bead, or a COB light bead.

8. The light strip structure according to claim 7, wherein one end of the light strip units is provided with a wire and an interface,
the light strip units are connected to the interface through the wire, and the interface is connected to an external power source or a control chip.

9. A luminous handicraft shell structure, comprising the light strip structure according to claim 1 and a handicraft shell, wherein the light strip structure is fixedly provided inside and/or outside the handicraft shell.

10. The luminous handicraft shell structure according to claim 9, wherein the handicraft shell comprises a first shell and a second shell;
the first shell and the second shell are fixedly connected or integrally formed.

11. The luminous handicraft shell structure according to claim 10, wherein a cavity is formed inside the first shell and the second shell, and the light strip structure is provided inside the cavity and/or outside the first shell and/or the second shell.

12. The luminous handicraft shell structure according to claim 11, wherein the first shell and the second shell are clamping connected.

13. The luminous handicraft shell structure according to claim 12, wherein an overall outer shape of the handicraft shell is deer horn shape, wing shape, pentagram shape, triangular shape or circular shape.

14. The luminous handicraft shell structure according to claim 13, wherein a luminous effect of the light strip structure is constant light, strobe light, or scrolling light.
